(19) United States
(12) Patent Application Publication
(10) Pub. No.: US 2006/0133607 A1
(43) Pub. Date: Jun. 22, 2006

(54) Apparatus and method for generating a secret key

(75) Inventors: Monty Aaron Forehand, Loveland, CO (US); Jon David Trantham, Chanhassen, MN (US); Laszlo Hars, Cranberry Township, PA (US); Charles William Thiesfeld, Lakeville, MN (US)

Correspondence Address: Robert P. Lenart;Pietragallo, Bosick & Gordon, One Oxford Centre, 38th Floor, 301 Grant Street, Pittsburgh, PA, 15219, US

(73) Assignee: Seagate Technology LLC, Scotts Valley, CA (US)

(21) Appl. No.: 11/021,875

(22) Filed: Dec. 22, 2004

(51) Int. Cl. H04L 9/00

(52) U.S. Cl. 380/44

(57) ABSTRACT

An apparatus comprises a circuit for generating a secret root key having bits representative of threshold voltages, and an error correction module for correcting errors in bits of the secret root key to produce a corrected secret root key. A method of generating a secret root key and a data storage system that includes a secret root key are also described.

### FIELD OF THE INVENTION

This invention relates to cryptographic keys, and more particularly to apparatus and methods for generating cryptographic keys.

### BACKGROUND OF THE INVENTION

In computer systems, cryptographic keys are used to control access to code or data. The keys always have to be passed across some medium, which can then be tapped to allow possible interception of the keys. In a secure system, a root key can be used to establish a primary root of trust, upon which the various keys and other security mechanisms are built. Root keys have been produced and stored using mechanisms, which are susceptible to software, network, and insider attacks that can compromise the root key during manufacture, distribution, and use of the system.

Keys in secure systems have been stored in non-volatile memories, including fuse/anti-fuse, EEPROM, flash, ROM, ferro-RAM, magneto-resistive RAM, and battery backed memories. However, these implementations involve human or machine interaction with the target device for generation and programming of the key or root key. This process inherently reveals the key to one or more machines, transports, and humans. This creates multiple opportunities for the key to be recorded and/or compromised. Additionally, these historical implementations store the key in a location in the system that is accessible to the host computer operating system or its ports, creating an additional opportunity for compromise after the computing system is delivered and put into service.

Technology exists to establish an identifier, for circuits implemented in silicon, without historical generation of a number and the associated programming of a non-volatile element. This technology, referred to as a silicon identifier, utilizes the randomness in the threshold voltage (Vₜ) of any transistor, in conjunction with a comparator, to generate identifier bits on the silicon without requiring a programming step. The identifier bits form an identification (ID) data word that is a function of the natural randomness in the threshold voltages in silicon transistors. The comparator compares Vₜ with a threshold voltage and produces a 0 or a 1 value in response to the comparison. The 0 or 1 becomes a bit in the data word.

A limitation of this technology is that transistors with Vₜ values that are very similar to the threshold value can result in a compared value that varies with time, temperature, voltage, and noise levels. Thus, due to environmental conditions, these transistors will sometimes produce a 1 and at other times produce a 0 value. Nevertheless, the silicon ID, is still “statistically unique”, meaning it can be determined with high probability which ID in the field corresponds to an ID realized in the factory.

For a security key, it is important that the bits of the key remain constant over time. If silicon ID technology is used to generate a key, there is a need for a method of achieving a stable ID over time.

### SUMMARY OF THE INVENTION

This invention provides an apparatus comprising a circuit for generating a secret root key having bits representative of threshold voltages, and an error correction module for correcting errors in bits of the secret root key to produce a corrected secret root key.

The invention also encompasses a method of producing a secret root key for an electronic device. The method comprises: producing a plurality of logic ones and zeros in response to transistor threshold voltages, and error correcting the plurality of logic ones and zeros to produce a corrected secret root key.

In another aspect, the invention provides a data storage system comprising a storage medium, a controller including a cryptographic and security module for encrypting and decrypting data to be stored in and retrieved from the storage medium, wherein the cryptographic and security module includes a circuit for generating a secret root key having bits representative of threshold voltages and an error correction module for correcting errors in bits of the secret root key to produce a corrected secret root key.

### BRIEF DESCRIPTION OF THE DRAWINGS

FIG. 1 is a block diagram of a key generating apparatus constructed in accordance with the invention.

FIG. 2 is a block diagram of a data storage system constructed in accordance with this invention.

FIG. 3 is a pictorial representation of a disc drive head disc assembly that can be included in a data storage system in accordance with the invention.

### DETAILED DESCRIPTION OF THE INVENTION

This invention provides apparatus and methods for generating and using a secret key that can be contained within a confined electronics module. The secret key can be employed in apparatus such that the secret key is never visible outside this electronics module.

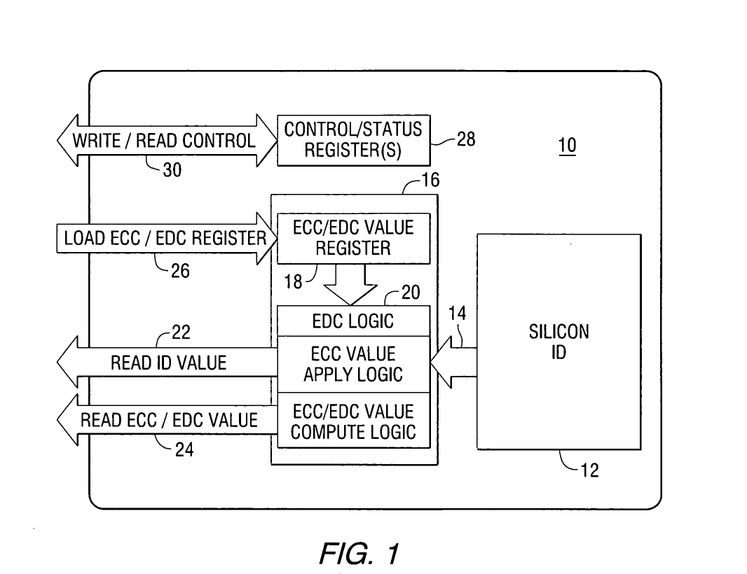

The method for producing the secret key improves upon the statistically unique silicon identifier technology by incorporating error correcting code (ECC) circuitry to create a secret key that does not change over time. FIG. 1 is a block diagram of a key generating apparatus 10 constructed in accordance with the invention. The apparatus of FIG. 1 includes a circuit 12 for generating a plurality of bits of a data word that serves as a secret root key. Circuit 12 can comprise a plurality of transistors and comparators in accordance with known techniques for generating a silicon ID. The silicon ID technology provides a good random number, but some of the bits can change over time. Since the root key must not change over time, an error correcting code (ECC) can be added. There will only be a small percentage of the bits that will change over time so a modest error correcting code is sufficient. The silicon ID circuit uses existing technology to generate a plurality of bits.

The silicon ID circuit produces an array of bits that are delivered on a bus 14 to error correction module 16. The bits delivered on bus 14 form an uncorrected secret root key. The error correction module includes a register 18 for storing an error correction code/error detection code (ECC/EDC) value, and error correction and error detection logic 20 for detecting correcting errors in the silicon ID data word. The ECC/EDC value contains two values, the first is the ECC or Error Correcting Code Value, and the second is the EDC or Error Detection Code Value. The corrected secret root key can be read on a bus 22 and the computed ECC/EDC value can be read on bus 24. A control and status register 28 is accessible via a write/read control bus 30.

Upon any power-up of the key apparatus in FIG. 1, the key apparatus does not allow reading of the corrected root key on bus 22. On first use of the apparatus, the apparatus is commanded via bus 30 and control register 28 to compute the ECC/EDC correction value for the plurality of silicon ID bits. The computed ECC/EDC value is read from bus 24 and stored in non-volatile memory for use on all subsequent power-up events. On subsequent power-up events, the apparatus will be loaded with the ECC/EDC correction value loaded via bus 26 into register 18. Upon loading of register 18, the apparatus will use the EDC portion of the correction value to determine if an error exists in the silicon ID value. If an error exists the apparatus will correct the raw silicon ID value using the ECC portion of the correction value. The resultant corrected key value will be stored in a register in correction module 16 and made available for reading on bus 22. If an error does not exist in the raw silicon identifier, the raw key will be stored in the register in the correction module 16, and made available for reading on bus 22. After initialization of this key value, the bus 22 will be enabled for reading of the key. The state of the apparatus will persist in this initialized state until a power-down event occurs.

The circuit of FIG. 1 can be implemented as a sub-block in an ASIC device and, when used in a disc drive, would be surrounded by the confined security electronics module. Error correction and detection can be implemented in hardware using a gate array.

The silicon identifier block requires no programming and the random, secret, statistically unique identifier is present after manufacture of the silicon device. The ECC circuitry is employed to generate an ECC value for correction of the instability of the identifier (ID) over the life of the device. The error correcting code can be varied with the nature of the statistics of the errors and will vary in its strength. For example, Reed-Solomon type coding can be used.

Reed-Solomon error correction is a coding scheme that works by first constructing a polynomial from the data bits. Because of the redundant information contained in the polynomial data, it is possible to reconstruct the original polynomial and thus the data bits even in the face of errors, up to a certain degree of error.

Reed Solomon codes are linear block codes. A Reed-Solomon code is specified as RS (n, k) with s-bit symbols. This means that the encoder takes k data symbols of s bits each and adds parity symbols to make an n symbol codeword. There are n−k parity symbols of s bits each. A Reed-Solomon decoder can correct up to t symbols that contain errors in a codeword, where 2t=n−k.

Additionally, the error correcting code can include capability for detecting that an error exists (Error Detecting Code or EDC). Error detection is used to determine whether the key has been corrupted. In one example, the error correction module constructs a value (called a checksum) that is a function of the message. The error detector can then use the same function to calculate the checksum of the received key and compare it with the appended checksum to see if the key was correctly received.

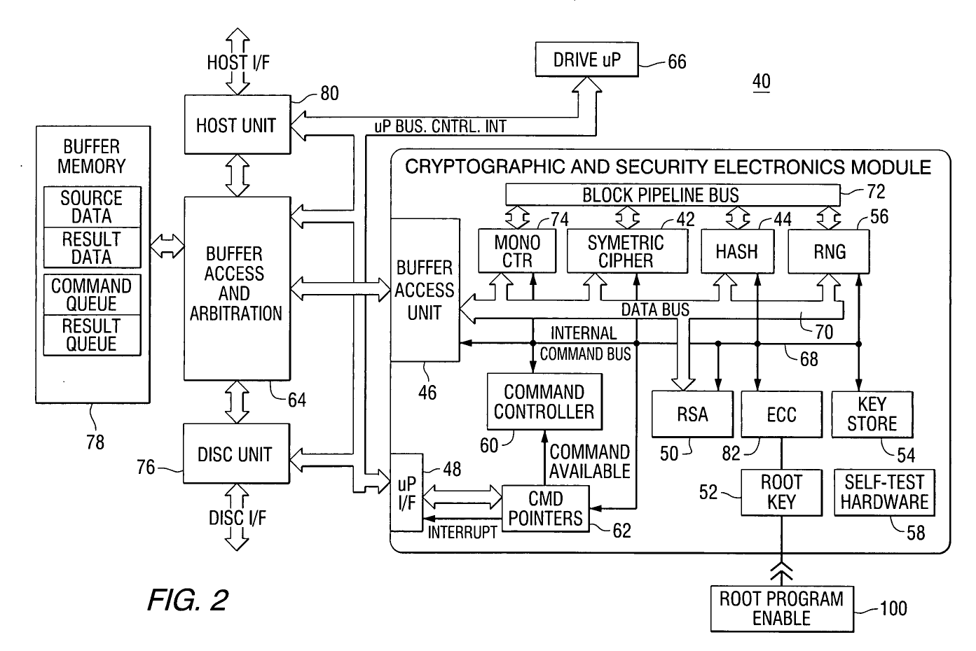

Silicon ID technology can be used to realize a unique and secret identifier for use as a root cryptographic key in the disc drive. FIG. 2 is a block diagram of an example of a controller for a data storage system, which uses a secret root key. A cryptographic and security module 40 contains a symmetric encryption module (or cipher block) 42, a hashing module 44, a buffer access unit/direct memory access (DMA) 46, a microprocessor interface 48, an asymmetric encryption acceleration module 50, a root key 52, a key store 54, a random number generator (RNG) 56, self-test hardware 58, and a command controller 60 for receiving and interpreting commands from the drive firmware. An optional command pointer module 62 can be provided for storing pointers to optional command and result queues in the buffer memory.

The symmetric cipher block 42 is used to provide symmetric encryption of data. In one example the symmetric encryption module can include Advanced Encryption Standard (AES) and Triple Data Encryption Standard (TDES) algorithms. The hash module 44 is provided for hashing of data. The hash module can be implemented using an SHA-1 algorithm. The asymmetric encryption acceleration module 50 can use, for example, a 1024 and 2048 bit Rivest, Shamir, Adleman (RSA) algorithm.

The system microprocessor interface 48 provides the connection between the cryptographic and security module and the system microprocessor. This connection is used to transfer commands to and retrieve status from the cryptographic and security module. In one embodiment, this connection is a parallel address and data bus, but it may also be implemented with a serial port connection. The system microprocessor interface can also include a hardware interrupt signal line that attaches directly to the system microprocessor interrupt controller. This interrupt would be used to notify the system microprocessor of the completion of a command, and of results available in the buffer.

The cryptographic and security module connects to a DRAM controller 64 and a drive microprocessor 66 as shown in FIG. 2. The cryptographic and security module contains an internal command bus 68 and data bus 70 for communication amongst internal sub-circuits and a block pipeline bus 72 for chaining of cryptographic operations. The buffer access unit and microprocessor interface circuitry adapt data flow to the protocols of the respective attached busses.

A monotonically increasing counter circuit 74 provides for secure knowledge of relative time. The cryptographically good random number generator 56 provides random numbers with technical infeasibility of prediction. The key store 54 can be a volatile memory for storing temporary keys.

The command controller 60 is provided for receipt and decoding of commands received from the system microprocessor and for tasking of the sub-circuitry. The command controller has the primary responsibility for decoding commands and setting microprocessor sub-blocks for the desired operation, and data flow. The command controller can also sequence the operations required to perform the RSA computations. The command controller has the primary responsibility for decoding commands and setting microprocessor sub-blocks for the desired operation, and data flow. The command controller is also expected to sequence the operations required to perform the RSA computations.

To preserve the integrity of the access to the cryptographic and security module, it is important that there be no alternate accessibility to the cryptographic and security module, outside of the defined command interface described above. This will ensure that attackers cannot make malicious access to the module using debug or manufacturing pathways. Because of these constraints, the module can include an internal self-test unit.

This self-test unit can be used to verify the correct functionality of the module while preventing “back-door” access to the cryptographic and security module. The self-test module can also be invoked during normal operation of the chip, in a drive, to verify continued correct functionality of the cryptographic and security module. The self-test hardware 58 autonomously ensures correct functionality of the cryptographic and security circuitry.

The cryptographic and security module is coupled to the disc unit 76 through the buffer access and arbitration unit 64. A buffer memory 78 stores various information designated as source data, result data, command queue, and result queue. The buffer manager provides buffer access and arbitration. A host unit 80 interacts with the buffer manager. The drive microprocessor 66 is coupled to the host unit, buffer manager, disc unit, and the cryptographic and security module.

The random number generator (RNG) 56 provides cryptographically good random numbers, meaning that it is technically infeasible to predict what any given number will be. In addition to the random number generation, the block will work in conjunction with the system microprocessor to provide a randomness quality monitor and to generate random primes to be used in RSA key-pair generation.

The random number generator provides random numbers for the following: a random number for the root key 52, random numbers to be distributed within the crypto block to other crypto sub-blocks, random numbers for the system microprocessor, and a stream of random numbers to be stored in the buffer memory and potentially on the disc.

Error correction can be provided as illustrated in FIG. 1 to account for possible error in the root key. The ECC block would be commanded, via the register interface, to compute the ECC correction value for the secret key. This correction value would then be returned to the upper level system for storage in some non-volatile memory. The correction value is the value that is applied to the uncorrected secret key to get the corrected secret key.

In the disc drive example, the ECC correction value is returned to the system microprocessor and stored to the non-volatile disc drive medium and/or other non-volatile storage element on the disc drive circuit board. On every subsequent initialization of the secret key, the secret key will default to the disabled state and operations with the secret key will not be allowed until the secret key is initialized. On each initialization, the ECC module will be loaded with the ECC correction value and each use of the silicon identifier will have the ECC correction value invoked. Upon determination of an error, the ECC module will perform the correction, and provide the corrected secret key to its output, to be used by the security and cryptographic elements in an associated electronics module.

When used in a disc drive, the secret key is only accessible within a cryptographic and security electronics module. The cryptographic and security module contains cryptographic and security elements which utilize the secret key for cryptographic and security operations. In the embodiment depicted in FIG. 2, the security module containing monotonic counter, symmetric cipher, hashing, and RSA electronics modules, in addition to the root key.

The cryptographic and security module of FIG. 2 can be implemented as an application specific integrated circuit (ASIC) containing a well-confined security electronics module, which contains the secret root key, for performing secure operations within said module. In a secure computing system, having the root key on the disc drive establishes a more secure root of trust as the root key is not visible to host computer operating system and the ports associated with the host computer system. Additionally, confining the root key to a controlled electronics block in the disc drive provides additional security from attack on the disc drive itself, and its ports. When the root key is realized in a secret manner, the system is more secure, as compromising the key becomes exponentially more difficult, as the key is never available for compromise throughout the manufacture, delivery, and use of the secure disc drive. The secret key provides greater security, when the secret key is cryptographically random in its value, as it is technically infeasible to guess the value of any given secret key.

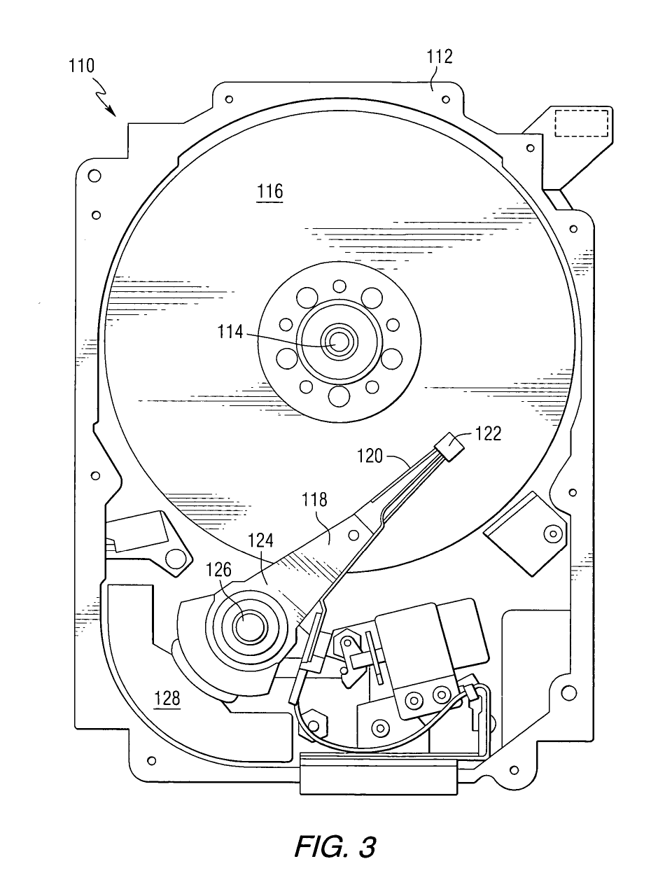

FIG. 3 is a pictorial representation of the mechanical portion of a disc drive 110 (commonly referred to as the Head Disc Assembly), that can be included in a data storage system in accordance with the invention. The disc drive includes a housing 112 (with the upper portion removed and the lower portion visible in this view) sized and configured to contain the various components of the disc drive. The disc drive includes a spindle motor 114 for rotating at least one data storage medium 116 within the housing, in this case a magnetic disc. At least one arm 18 is contained within the housing 112, with each arm 118 having a first end 120 with a recording and/or reading head or slider 122, and a second end 124 pivotally mounted on a shaft by a bearing 126. An actuator motor 128 is located at the arm's second end 124, for pivoting the arm 118 to position the head 122 over a desired sector of the disc 116. The actuator motor 128 is regulated by a controller that is not shown in this view. A complete disc drive includes the head disc assembly of FIG. 4 and the controller circuitry of FIG. 2.

This invention produces the secret key within the cryptographic and security module ensuring that the secret key is never visible outside of this module and thus, is never compromised. Once realized, this cryptographically random secret root of trust can be used secretly within the disc drive system to support additional security functions in support of a secure disc drive and a secure computing system. These functions can include, but, are not limited to: secure bootstrapping of the disc drive and computer system, secure bootstrapping of keys and initial values, secure accounting of time across power cycles, and other secure functions. Each data storage system can have its own unique identifier or key that is permanently stored in the system.

In addition to the disclosed examples, it should be recognized that the electronic device and method of producing a key of this invention can be utilized in a plurality of electronic devices and systems that require the generation of a cryptographic key or other stable data word. This invention facilitates the generation of a cryptographic key or data word without the need to program a key generator.

While the invention has been described in terms of several examples, it will be apparent to those skilled in the art that various changes can be made to the disclosed examples without departing from the scope of the invention as set forth in the following claims.

What is claimed is:

1. An electronic device comprising:
a circuit for generating a secret root key having bits representative of threshold voltages; and
an error correction module for correcting errors in bits of the secret root key to produce a corrected secret root key.

2. The electronic device of claim 1, wherein the circuit for generating a secret root key comprises a silicon identifier circuit.

3. The electronic device of claim 2, wherein the threshold voltages are transistor threshold voltages.

4. The electronic device of claim 1, wherein the error correction module includes error correction and error detection circuitry.

5. The electronic device of claim 1, wherein the error correction module comprises a gate array.

6. The electronic device of claim 1, wherein the error correction module applies a block error correction code.

7. The electronic device of claim 6, wherein the error correction code comprises a Reed Solomon code.

8. A method of producing a secret root key for an electronic device, the method comprising:
producing a plurality of logic ones and zeros in response to threshold voltages; and
error correcting the plurality of logic ones and zeros to produce a corrected secret root key.

9. The method of claim 8, wherein the plurality of logic ones and zeros comprises a silicon identifier.

10. The method of claim 9, wherein the threshold voltages are transistor threshold voltages.

11. The method of claim 8, wherein the error correcting step applies a block error correction code to the plurality of logic ones and zeros.

12. The method of claim 11, wherein the block error correction code comprises a Reed Solomon code.

13. The method of claim 8, further comprising:
detecting errors in the plurality of logic ones and zeros prior to error correcting the series of logic ones and zeros to produce a corrected secret root key.

14. The method of claim 13, wherein the step of detecting errors compares a checksum in the plurality of logic ones and zeros with a generated checksum.

15. A data storage system comprising:
a storage medium;
a controller including a cryptographic and security module for encrypting and decrypting data to be stored in and retrieved from the storage medium, wherein the cryptographic and security module includes:
a circuit for producing a secret root key having bits representative of threshold voltages; and
an error correction module for correcting errors in bits of the secret root key.

16. The data storage system of claim 15, wherein the threshold voltages are transistor threshold voltages.

17. The data storage system of claim 15, further comprising:
a circuit for generating multiple derived keys from the secret root key; and
an encryption and decryption unit for encrypting and decrypting data using the derived keys.

18. The data storage system of claim 15, wherein the error correction module comprises a gate array.

19. The data storage system of claim 15, wherein the error correction module applies a block error correction code.

20. The data storage system of claim 19, wherein the error correction code comprises a Reed Solomon code.
